(19) United States
(12) Patent Application Publication
(10) Pub. No.: US 2004/0216111 A1
(43) Pub. Date: Oct. 28, 2004

(54) Multi-tier application architecture

(76) Inventor: Aavishkar Bharara, Bangalore (IN)

Correspondence Address: Patrick W. Rasche, Armstrong Teasdale LLP, Suite 2600, One Metropolitan Square, St. Louis, MO, 63102, US

(21) Appl. No.: 10/800,769

(22) Filed: Mar. 15, 2004

(30) Foreign Application Priority Data
Mar. 17, 2003 (JP) 2003-071867

(51) Int. Cl. G06F 9/46

(52) U.S. Cl. 718/102

(57) ABSTRACT

The present invention aims at providing a multi-tier application architecture that fast accesses objects and has a fail-safe function against middletier crash. A framework mediates between an application and a middletier and allows the middletier to execute an object fetched by the application from a cache. When an object becomes stale, the framework repeatedly refreshes that object within a limited number of retries. When the refresh succeeds, the framework returns the object to the cache and again allows the middletier to execute the object. When the refresh does not succeed within the specified number of retries, the framework quits the application in a fail-safe state.

### BACKGROUND OF THE INVENTION

The present invention relates to a multi-tier application architecture. More specifically, the present invention relates to a multi-tier application architecture having middletiers such as an application server and a Web server.

In the multi-tier application architecture, a business logic for applications is executed in a middletier. An application specifies the business logic as an object in the middletier. The middletier executes the specified object (e.g., see non-patent documents 1 and 2). A service locator is used to access objects in the middletier (e.g., see non-patent document 3).

[Non-patent document 1]

Gould, Steven. “Develop n-tier applications using J2EE”, FIG. 2, 2002, JavaWorld.com, Java World, p. 3/10. The document is retrieved online from the following Internet location on Jan. 23, 2003.

URL:http://www.javaworld.com/javaworld/jw-12-2000/jw-1201/weblogic_p.html

[Non-patent document 2]

Baldwin, Richard G “A Middle-Tier Serer” in “Enterprise JavaBeans: Middle-Tier Servers and J2EE”, 2002, Jupitermedia Corporation, a search result for “developer.com+GAMELAN”, pp. 4/12-5/12. The document is retrieved online from the following Internet location on Dec. 11, 2002.

URL:http://www.developer.com/java/other/article.php/641331

[Non-patent document 3]

“Solution” in “Sun Java Center J2EE Patterns Service Locator”, 2002, Sun Microsystems, Inc., Java Technology Home Page, pp. 3/12-6/12. The document is retrieved online from the following Internet location on Dec. 24, 2002.

URL:file://C:\WINDOWS\TEMP\TD_{—}0024.DIR\Sun%20Java%20Center%20%30Service%20Locator%20J2EE%30Patterns.htm

According to the above-mentioned multi-tier application architecture, accessing objects in the middletier uses the service locator, thus slowing down application operations.

When the middletier crashes, an object becomes stale, causing the application to hang up. However, there is no fail-safe mechanism for such case. An application hangup may cause secondary anomalies such as interference with the other applications.

### SUMMARY OF THE INVENTION

It is therefore an object of the present invention to provide a multi-tier application architecture in which access to objects is fast and a fail-safe function against middletier crash is provided. In this specification, the architecture signifies a computer program architecture.

In order to solve the above-mentioned problem, the present invention provides a multi-tier application architecture having a middletier comprising: a framework to mediate between an application and a middletier, wherein the framework allows a middletier to execute an object fetched by an application from a cache; when an object becomes stale, the framework repeatedly refreshes the object within a limited number of retries; when an object refresh succeeds, the framework returns the object to the cache and again allows the middletier to execute the object; and when an object refresh does not succeed within a limited number of retries, the framework quits an application in fail-safe way.

According to the present invention, a framework mediates between an application and a middletier and allows the middletier to execute an object fetched by the application from a cache. When an object becomes stale, the framework repeatedly refreshes that object within a limited number of retries. When the refresh succeeds, the framework returns the object to the cache and again allows the middletier to execute the object. When the refresh does not succeed within the specified number of retries, the framework quits the application in a fail-safe state. Accordingly, it is possible to provide a multi-tier application architecture that fast accesses objects and has a fail-safe function against middletier crash.

It is desirable to make the limited number of retries user-specifiable so as to be able to satisfy needs for the limited number of retries. It is desirable to make the time interval user-specifiable so as to be able to satisfy needs for the time interval. It is desirable to visualize operations of the framework to a user so that the user can easily understand operational states.

It is desirable to provide a watchdog to resume normal operations when the middletier crushes from the viewpoint of automating the recovery. It is desirable that the watchdog recovers a middletier based on a result of periodical polling from the viewpoint of watchdog-based recovery from a crush. It is desirable that the watchdog recovers a middletier based on notification from the framework from the viewpoint of framework-based recovery from a crush.

Therefore, the present invention can implement a multi-tier application architecture in which accesses to objects is fast and the fail-safe function against middletier crash is provided.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing a configuration of an embodiment according to the present invention.

FIG. 2 is a block diagram showing in more detail a configuration of a front-end tier according to the embodiment of the present invention.

FIG. 3 is another block diagram showing in more detail the configuration of the front-end tier according to the embodiment of the present invention.

FIG. 4 is yet another block diagram showing in more detail the configuration of the front-end tier according to the embodiment of the present invention.

### DETAILED DESCRIPTION OF THE INVENTION

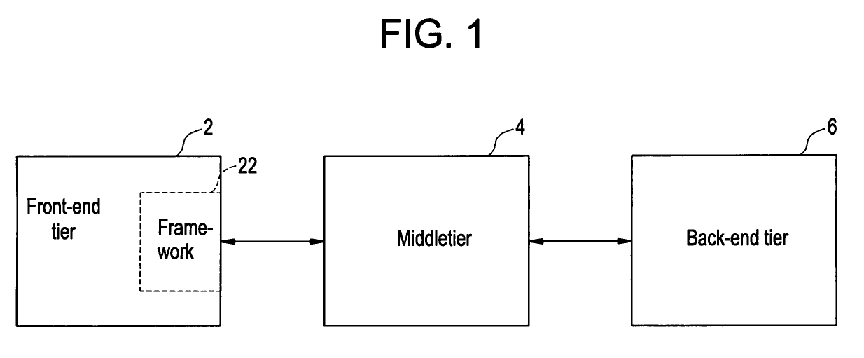

Embodiments of the present invention will be described in further detail with reference to the accompanying drawings. FIG. 1 is a block diagram showing a configuration of the multi-tier application architecture. This architecture is an example of the embodiments according to the present invention. The configuration of this architecture exemplifies an embodiment of the multi-tier application architecture according to the present invention.

As shown in FIG. 1, the architecture has a front-end tier 2, a middletier 4, and a back-end tier 6.

The front-end tier is equivalent to a client. The middletier 4 is equivalent to an application server. The back-end tier is equivalent to an EIS (enterprise information service) such as a database server, for example. There may be provided another middletier such as a Web server between the front-end tier 2 and the middletier 4.

The front-end tier 2 has an application that uses resources such as a database of the back-end tier 6. The middletier 4 services execution of a business logic the application needs.

The front-end tier 2 requests the middletier 4 to execute the business logic. This request is given as an object. The object is supplied to the middletier 4 via a framework 22 in the front-end tier 2.

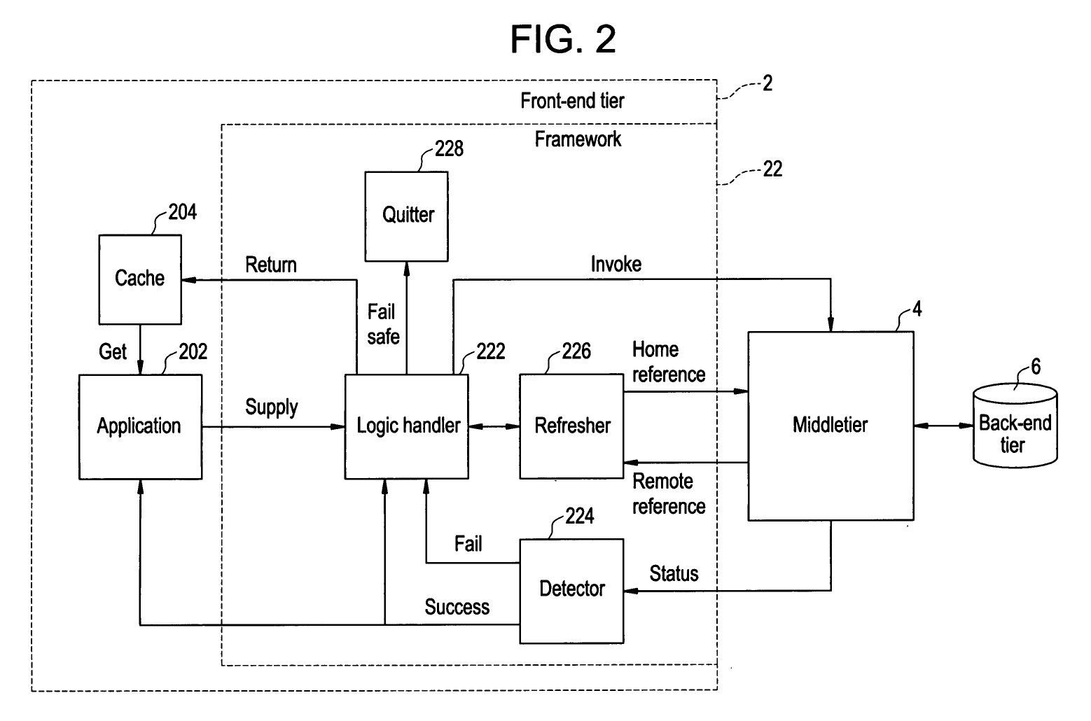

FIG. 2 shows a configuration of a major part of the front-end tier 2 including the framework 22, along with the middletier 4 and the back-end tier 6. As shown in FIG. 2, the front-end tier 2 has an application 202 and a cache 204.

The cache 204 stores all or major objects the application 202 uses. The objects are stored as remote references.

Since the cache 204 stores remote references to all or major objects the application 202 uses, there is no need for remote reference look-up using a home reference. This speeds up application operations.

The framework 22 has a logic handler 222, a detector 224, a refresher 226, and a quitter 228.

The application 202 fetches one object from the cache 204 and supplies it to the logic handler 222. The logic handler 222 uses that object to invoke a corresponding business logic for the middletier 4.

The middletier 4 executes the business logic. The detector 224 detects an execution state and an execution result of the business logic. The logic handler 222 is notified whether the business logic has succeeded or failed. The success state is also notified to the application 202.

When the business logic has executed successfully, the logic handler 222 returns the executed object to the cache. The application 202 fetches a new object from the cache 204 and supplies it to the logic handler 222. While the business logic execution is successful, the above-mentioned process is repeated.

When the business logic execution fails, the object becomes stale. At this time, the logic handler 222 allows the refresher 226 to refresh the stale object. The refresh is executed as follows.

The refresher 226 allows the middletier 4 to look up a remote reference using the object's home reference.

When the look-up succeeds, the middletier 4 returns the remote reference to the refresher 226. This refreshes the stale object. The logic handler 222 returns the refreshed object to the cache 204 and reinvokes that object. In this manner, the stale object can be restored.

When the look-up is unsuccessful, no remote reference returns. Thus, the look-up is retried. While the look-up is unsuccessful, it is retried. That is, the refresh is retried more than once. This improves a success rate of refreshing objects.

An upper bound for the number of repetitions and a time interval for repetition are previously determined. It is desirable to make the number of repetitions and the time interval user-specifiable so as to be able to satisfy needs.

Even if the number of repetitions reaches the upper bound, the refresh may remain unsuccessful. In such case, the logic handler 222 allows the quitter 226 to execute a fail-safe process. The quitter 226 releases various resources dedicated to the application 202 and the like to quit the application 202 in fail-safe way. The fail-safe process makes it possible to smoothly restart the application 202 thereafter. Further, it is possible to prevent interference with the other applications that share the resources.

This framework 22 is especially suitable for entity beans and stateless session beans.

A user can identify operational states of the framework. An appropriate GUI (graphical user interface) and the like can be used for this purpose. Such facility allows the user to easily understand operational states. The facility can be omitted if unneeded.

The business logic in the middletier 4 fails when the middletier crushes or the like. The utilization of the middletier 4 can be improved by automatically recovering a crush if occurred. It becomes possible to effectively execute applications.

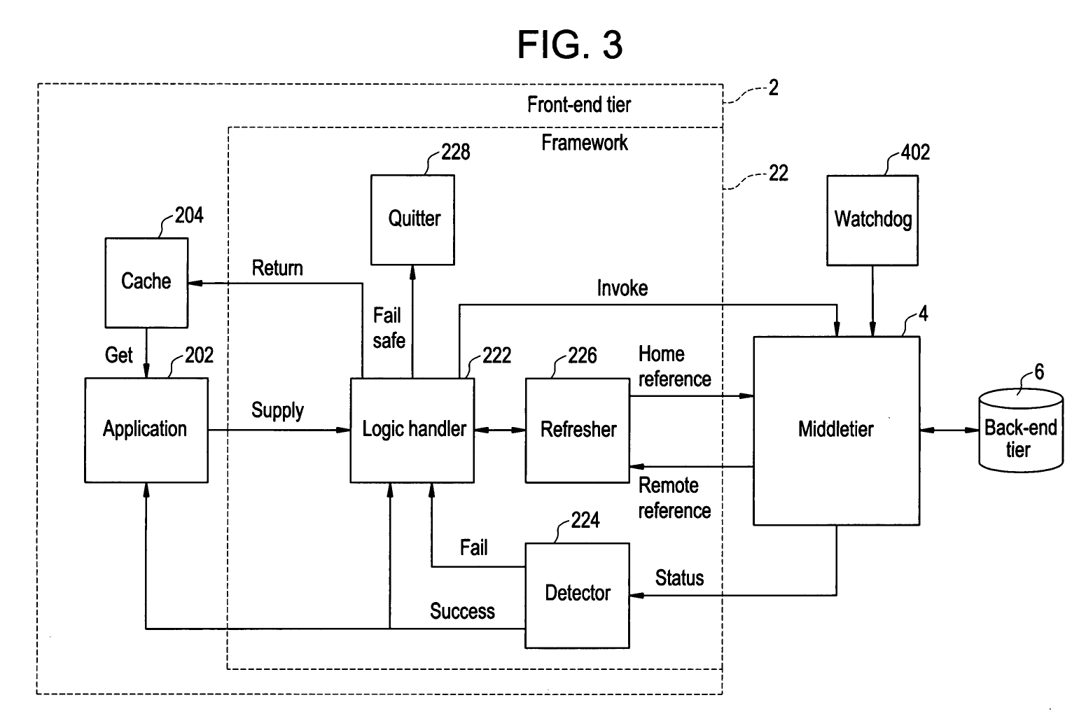

As shown in FIG. 3, a watchdog 402 is used to automatically recover the crushed middletier 4. The watchdog 402 periodically performs polling to whether or not the middletier 4 crushes. The watchdog 402 recovers the middletier 4 when it crushes. The watchdog 402 can be implemented by using a shell script and the like.

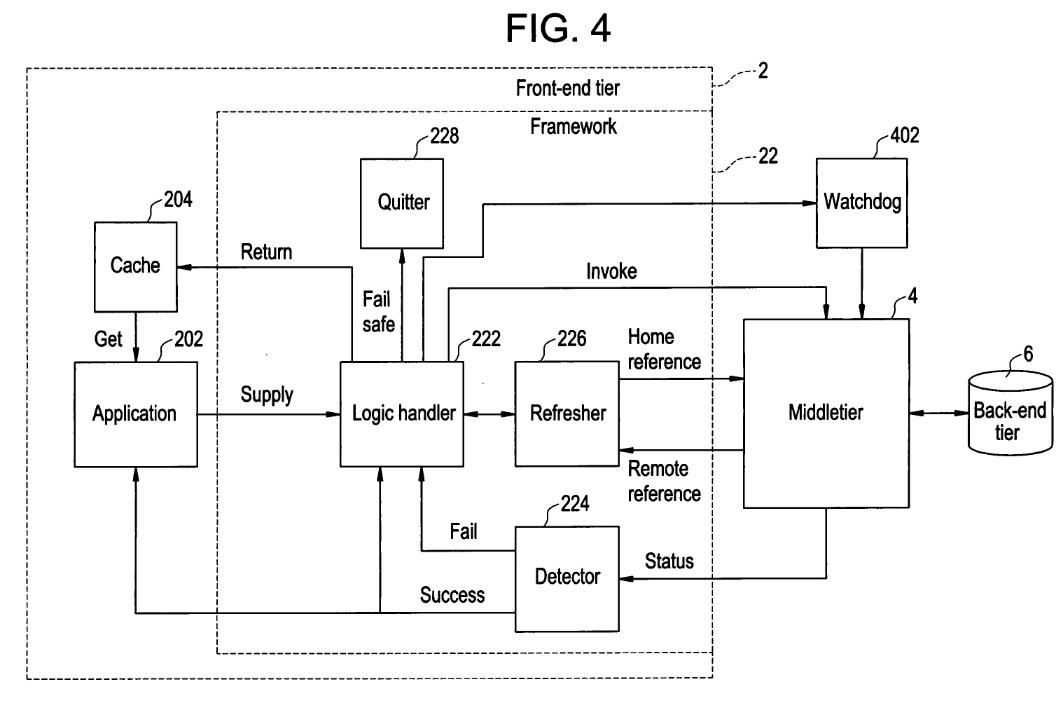

As shown in FIG. 4, the watchdog 402 may recover the middletier 4 based on a crush notification from the logic handler 222. A special application or the like may be used to implement the watchdog 402. A crush of the middletier 4 is notified when the logic handler 222 cannot recover an object after refreshing.

Many widely different embodiments of the invention may be constructed without departing from the spirit and the scope of the present invention. It should be understood that the present invention is not limited to the specific embodiments described in the specification, except as defined in the appended claims.

1. A multi-tier application architecture having a middletier comprising:
a framework to mediate between an application and a middletier,
wherein the framework allows a middletier to execute an object fetched by an application from a cache;
wherein, when an object becomes stale, the framework repeatedly refreshes the object within a limited number of retries;
wherein, when an object refresh succeeds, the framework returns the object to the cache and again allows the middletier to execute the object; and
wherein, when an object refresh does not succeed within a limited number of retries, the framework quits an application in fail-safe way.

2. The multi-tier application architecture according to claim 1, wherein a user can specify the limited number of retries.

3. The multi-tier application architecture according to claim 2, wherein a user can specify a time interval between the retries.

4. The multi-tier application architecture according to claim 1, wherein the framework has its operations visualized to a user.

5. The multi-tier application architecture according to claim 1, further including a watchdog to resume normal operations when the middletier crashes.

6. The multi-tier application architecture according to claim 5, wherein the watchdog recovers a middletier based on a result of periodical polling.

7. The multi-tier application architecture according to claim 5, wherein the watchdog recovers a middletier based on notification from the framework.
